(19) United States
(12) Patent Application Publication
(10) Pub. No.: US 2003/0165661 A1
(43) Pub. Date: Sep. 4, 2003

(54) Cordierite ceramic honeycomb of low thermal expansion and method for manufacturing the same

(76) Inventors: Yasushi Noguchi, Aichi (JP); Kyoko Makino, Aichi (JP)

Correspondence Address: Parkhurst & Wendel, Suite 210, 1421 Prince Street, Alexandria, VA, 22314-2805, US

(21) Appl. No.: 10/204,133

(22) PCT Filed: Apr. 6, 2001
(86) PCT No.: PCT/JP01/03002

(30) Foreign Application Priority Data
Apr. 7, 2000 (JP) 2000-105875

(51) Int. Cl. B32B 3/12

(52) U.S. Cl. 428/116

(57) ABSTRACT

A low thermal expansion cordierite ceramic honeycomb is obtained by controlling crystal phases in such a manner that a cordierite crystal phase is not lower than 60% and an indialite crystal phase is not greater than 30%, wherein a sum of the cordierite crystal phase and the indialite crystal phase is not lower than 85%. Moreover, to this end, a method of producing the low thermal expansion cordierite ceramic honeycomb, having the steps of mixing raw materials and forming agents to obtain a raw materials batch, extruding and drying the raw material batch to obtain a formed body, and sintering the formed body, is characterized in that, during the sintering step, a temperature descending rate at least from a maximum temperature to 1300° C. is not greater than 100° C./hour.

### TECHNICAL FIELD

The present invention relates to a low thermal expansion cordierite ceramic honeycomb and a method of producing the same, which can obtain a low thermal expansion honeycomb structural body.

### BACKGROUND ARTS

Generally, as a technique for obtaining a cordierite ceramic honeycomb structural body having a low thermal expansion coefficient, various techniques have been known. For example, in Japanese Patent Publication No. 5-82343 (JP-B-5-82343), there disclosed a cordierite ceramic honeycomb having properties such as a porosity: 30-42%, a thermal expansion coefficient along A-axis: not greater than 0.3×10⁻⁶/° C., and a thermal expansion coefficient along B-axis: not greater than 0.5×10⁻⁶/° C., which was produced by using talc having an average particle size of 5-100 μm, alumina having an average particle size of not greater than 2 μm, and a high-purity amorphous silica having an average particle size of not greater than 15 μm. Moreover, in Japanese Patent Publication No. 4-70053 (JP-B-4-70053), there disclosed a cordierite ceramic honeycomb having properties such as a porosity: not greater than 30%, a thermal expansion coefficient along A-axis: not greater than 0.8×10⁻⁶/° C., and a thermal expansion coefficient along B-axis: not greater than 1.0×10⁻⁶/° C., whose crystal amount is not lower than 90% of cordierite, not greater than 2.5% of mullite, and not greater than 2.5% of spinet (including sapphirine). Further, in Japanese Patent Laid-Open Publication No. 50-75611 (JP-A-50-75611), there disclosed a poly-crystal sintered ceramic having property such as a thermal expansion coefficient in a temperature range of 25-1000° C. of not greater than 1.1×10⁻⁶/° Cm whose crystal phase is cordierite of orthorhombic system (or cordierite of hexagonal system known as indialite) as a main crystal phase.

In the case of producing a thin wall honeycomb that is highly required recently, whose rib thickness is not greater than 100 μm, it is preferred to have a porosity of not lower than 30% so as to easily coat a catalyst to the thin wall honeycomb. Moreover, it is necessary to exclude a coarse particle component having a diameter not greater than a slit width of a die from raw material particles so as to prevent a failure of a rib. Further, it is required to have a low thermal expansion coefficient so as to maintain a thermal shock resistance. However, in the known techniques mentioned above, there are following problems. That is, a fine alumina having an average particle size of not greater than 2 μm has an advantage such that a thermal expansion coefficient decreases. On the other hand, in such a fine alumina, particles are strongly agglutinated, and thus it is difficult to classify particles. Therefore, it is not possible to remove the coarse particle component. In this case, the alumina coarse particle plugs the slit of the die during a honeycomb forming step, and this plugging causes a rib failure of the honeycomb. Moreover, there is a drawback such that a porosity of the cordierite ceramic honeycomb decreases since use is made of the fine alumina. Further, the high-purity amorphous silica has an advantage such that a thermal expansion coefficient decreases. On the other hand, the high-purity amorphous silica decreases a porosity of the cordierite ceramic honeycomb as compared with quartz silica, and also there is a drawback such that it is expensive.

### DISCLOSURE OF INVENTION

An object of the present invention is to eliminate the drawbacks mentioned above and to provide a low thermal expansion cordierite ceramic honeycomb and a method of producing the same, which can obtain a honeycomb structural body having a low thermal expansion coefficient.

According to the invention, a low thermal expansion cordierite ceramic honeycomb is characterized in that a cordierite crystal phase is not lower than 60% and an indialite crystal phase is not greater than 30%, wherein a sum of the cordierite crystal phase and the indialite crystal phase is not lower than 85%.

Moreover, according to the invention, a method of producing the low thermal expansion cordierite ceramic honeycomb mentioned above, having the steps of mixing raw materials and forming agents to obtain a raw materials batch, extruding and drying the raw material batch to obtain a formed body, and sintering the formed body, is characterized in that, during the sintering step, a temperature descending rate at least from a maximum temperature to 1300° C. is not greater than 100° C./hour.

During a development of the known low thermal expansion ceramic, raw materials were varied so as to improve an orientation and a reaction of cordierite. However, in the present invention, crystal phases to be generated are controlled by controlling a temperature during a crystal generation (i.e. a temperature descending rate from a maximum temperature), so that a low thermal expansion coefficient can be achieved. As a crystal phase of cordierite, there are cordierite of orthorhombic system and cordierite of hexagonal system i.e. different phase of indialite. In the present invention, it is possible to decrease a thermal expansion coefficient by increasing an amount of cordierite and by decreasing an amount of indialite. Moreover, it is found that a ration between cordierite and indialite can be controlled by a temperature descending rate during a sintering step from the maximum temperature to a predetermined temperature.

### BRIEF DESCRIPTION OF THE DRAWING

FIG. 1 is a flowchart showing one embodiment of a method of producing a cordierite ceramic honeycomb according to the invention.

### BEST MODE FOR CARRYING OUT THE INVENTION

In a low thermal expansion cordierite ceramic honeycomb according to the present invention, crystal phases after a sintering step include not lower than 60% of cordierite crystal phase and not greater than 30% of indialite crystal phase, wherein a sum of the cordierite crystal phase and the indialite crystal phase is not lower than 85%. The low thermal expansion cordierite ceramic honeycomb having the crystal phases mentioned above can be obtained according to the following producing method.

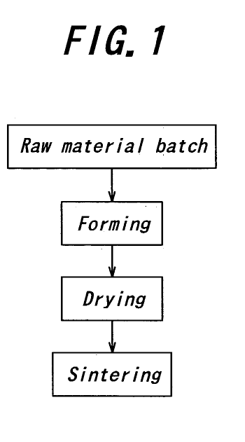

FIG. 1 is a flowchart showing one embodiment of a method of producing a cordierite ceramic honeycomb according to the invention. The method of producing the cordierite ceramic honeycomb will be explained with reference to FIG. 1. At first, a raw material batch for making cordierite is prepared. The raw material batch is obtained by adding and mixing forming agents such as soluble cellulose derivatives, surfactants, water and so on with respect to raw materials for making cordierite made of, for example, talc, kaolin, calcined kaolin, alumina, aluminum hydroxide and quartz. Then, the thus obtained raw material batch is extruded by using a die to obtain a honeycomb formed body having a cordierite composition. After that, the thus obtained honeycomb formed body is dried to obtain a honeycomb dried-up body. Finally, the cordierite ceramic honeycomb can be obtained by sintering the honeycomb dried-up body.

A feature of the producing method mentioned above is that, during the sintering step, a temperature descending rate at least from the maximum temperature to 1300° C. is controlled to not greater than 100° C./hour. In the present invention, it is possible to produce a cordierite ceramic honeycomb having a low thermal expansion coefficient, which increases the cordierite crystal phase and decreases the indialite crystal phase, by controlling gradually the temperature descending rate during the sintering step from the maximum temperature in such a manner that it becomes not greater than 100° C./hour.

In the embodiment mentioned above, it is preferred to use quartz in the raw material batch for making cordierite and to use alumina having an average particle size greater than 2 μm. In the present invention, it is possible to use quartz silica instead of known high-purity amorphous silica. In this case, it is preferred since the quartz silica can increase porosity and reduce the cost as compared with the known high-purity amorphous silica. Moreover, the use of alumina having an average particle size greater than 2 μm is to make the porosity not lower than 30% and to prevent an inclusion of coarse particle component that is difficult to classify. Further, if the temperature descending rate from the maximum temperature to 1250° C. is not greater than 50° C./hour and if the maximum temperature maintaining period is not lower than 6 hours, it is further preferred since the present invention can be achieved preferably.

The cordierite ceramic honeycomb according to the invention, which is obtained according to the producing method mentioned above, has an excellent low thermal expansion coefficient such that a thermal expansion coefficient along A-axis in a temperature range from 40° C. to 800° C. is not greater than 0.4×10⁻⁶/° C. and a thermal expansion coefficient along B-axis is not greater than 0.6×10⁻⁶/° C., more preferably, such that a thermal expansion coefficient along A-axis is not greater than 0.3×10⁻⁶/° C. and a thermal expansion coefficient along B-axis is not greater than 0.5×10/° C. Moreover, it is possible to set the porosity to not lower than 30%, and thus it is possible to easily coat a catalyst thereto. Therefore, the present invention can be applied preferably for producing a honeycomb structural body having a thickness of cell partition wall of not greater than 100 μm.

Hereinafter, actual examples will be explained.

According to the producing method mentioned above, a honeycomb dried-up body having a cordierite composition was produced by; mixing raw materials shown in the following Table 1 at a mixing proportion as shown in Table 1 to obtain a mixture; adding soluble cellulose derivatives, surfactants and water to the mixture; and admixing, kneading, extruding and drying the mixture in which forming agents are added.

TABLE 1
Raw materials to be used and mixing proportion

| | Average | | |
|---|---|---|---|
| | particle | +45 μm screen | Mixing proportion |
| Raw materials | size (μm) | residue (ppm) | (wt %) |
| Talc | 9 | 12 | 40 |
| Kaolin | 8 | 5 | 18 |
| Calcined kaolin | 3 | 8 | 16 |
| Alumina | 5 | 14 | 10 |
| Aluminum hydroxide | 1.8 | 13 | 10 |
| Quartz | 4 | 7 | 6 |

Then, the thus obtained honeycomb dried-up body was sintered. The sintering of the honeycomb dried-up body was performed on the basis of sintering conditions shown in the following Table 2, at a maximum temperature during the sintering of 1425° C., by means of a commercially available kanthal furnace with programming function, so that honeycomb sintered bodies of examples 1-8 of the invention and comparative examples 21-24 were obtained. With respect to the thus obtained respective honeycomb sintered bodies, porosity and thermal expansion coefficients were measured, and crystal phases of respective honeycomb sintered bodied were quantified. The porosity of the honeycomb sintered body was measured in such a manner that overall total-pore volume was measured by a method of mercury penetration and the porosity was calculated from the thus measured total-pore volume. A true density of cordierite was estimated as 2.52 g/cm³. The measurement was performed by means of Auto Pore 9405 manufactured by Micromeritics,inc. Moreover, the thermal expansion coefficient of the honeycomb sintered body was measured in such a manner that average thermal expansion coefficients along A-axis and B-axis were measured respectively in a temperature range of 40-800° C. In this case, A-axis means an extruding direction of the honeycomb and B-axis means a direction perpendicular to the extruding direction and parallel to the honeycomb partition wall lines. The quantification of crystal phases in the honeycomb sintered body was performed according to Rietvelt method. As an internal standard substance, use was made of corundum powders manufactured by U.C. co. ltd., and the quantitative analysis of cordierite and indialite was performed. Small amount components such as sapphirine, spinel and mullite were measured in a quantitative manner by dissolving powders of the honeycomb sintered body by means of hydrofluoric acid to obtain a remainder and subjecting the remainder to the quantitative analysis according to Rietvelt method. The glass amount was measured by subtracting sum of crystal phase percentages of cordierite, indialite, sapphirine, spinel and mullite from 100%. The results are shown in the following Table 2.

TABLE 2
Examples

| | Sintering conditions | | | | | | | | | | | |
|---|---|---|---|---|---|---|---|---|---|---|---|---|
| | Maximum | Temperature | | | | | | | | | | |
| | temperature | descending | Cooling | | Thermal expansion | | | | | | | |
| | maintaining | rate | temperature | Porosity | (×10⁻⁶/° C.) | | Crystal phase (%) | | | | | |
| No. | period (hr) | (° C./hr) | (° C.) | (%) | A-axis | B-axis | cordierite | indialite | sapphirine | spinel | mullite | glass |
| 1 | 12 | 100 | 1250 | 32.0 | 0.30 | 0.60 | 70.3 | 21.8 | 1.2 | 0.4 | 1.6 | 4.7 |
| 2 | 12 | 75 | 1250 | 32.3 | 0.27 | 0.57 | 73.6 | 18.6 | 1.8 | 0.3 | 1.3 | 4.4 |
| 3 | 12 | 50 | 1250 | 31.7 | 0.22 | 0.50 | 76.4 | 15.3 | 1.7 | 0.2 | 0.6 | 5.8 |
| 4 | 12 | 25 | 1250 | 31.9 | 0.24 | 0.52 | 80.1 | 13.2 | 1.3 | 0.3 | 0.8 | 4.3 |
| 5 | 12 | 25 | 1200 | 31.6 | 0.17 | 0.43 | 82.0 | 12.0 | 1.1 | 0.2 | 1.2 | 3.4 |
| 6 | 12 | 25 | 1000 | 31.3 | 0.20 | 0.48 | 82.5 | 11.9 | 1.2 | 0.2 | 0.9 | 3.3 |
| 7 | 6 | 25 | 1200 | 32.5 | 0.31 | 0.57 | 69.1 | 23.5 | 1.6 | 0.4 | 1.2 | 4.3 |
| 8 | 4 | 75 | 1200 | 33.1 | 0.40 | 0.61 | 62.2 | 28.7 | 1.4 | 0.4 | 2.4 | 4.9 |
| 9 | 12 | 100 | 1300 | 32.4 | 0.37 | 0.61 | 62.8 | 27.4 | 1.3 | 0.5 | 2.3 | 5.7 |
| 21 | 2 | 300 | 1250 | 31.7 | 0.57 | 0.77 | 49.7 | 39.3 | 1.1 | 0.5 | 3.3 | 6.1 |
| 22 | 12 | 150 | 1250 | 32.1 | 0.38 | 0.62 | 58.9 | 31.1 | 1.6 | 0.3 | 2.8 | 5.3 |
| 23 | 12 | 300 | 1250 | 31.7 | 0.46 | 0.65 | 53.5 | 36.5 | 1.3 | 0.4 | 3.0 | 5.3 |
| 24 | 12 | 100 | 1350 | 32.3 | 0.42 | 0.63 | 55.4 | 34.3 | 1.4 | 0.3 | 3.1 | 5.5 |

If a cooling from the maximum temperature became slower, an amount of cordierite crystal phase was increased and the thermal expansion coefficients became lower (examples 1-4). On the other hand, if the temperature descending rate became over 150° C./hour, an amount of cordierite crystal phase was decreased and the thermal expansion coefficients became higher (comparative examples 21-23). The gradual cooling from the maximum temperature was effective if it was performed in a temperature range from the maximum temperature to 1300° C. (example 9). Further, if the gradual cooling from the maximum temperature was performed to 1200° C., it was more effective (example 5). However, even if the gradual cooling from the maximum temperature was performed to further lower temperature, it was not so effective (example 6). On the other hand, if the gradual cooling from the maximum temperature was performed only to 1350° C., an amount of cordierite crystal phase was decreased, and it was not effective (comparative example 24). If the maximum temperature maintaining period became longer, an amount of cordierite crystal phase was increased and the thermal expansion coefficients became lower. If the maximum temperature maintaining period was at least over 4 hours, an amount of cordierite crystal phase became over 60% and the lower thermal expansion coefficients were obtained (referred to examples 2, 5, 7, 8). If the maximum temperature maintaining period was short and the temperature descending rate was high as shown in the comparative example 21, an amount of cordierite crystal phase was less than 60% and extraordinarily high thermal expansion coefficients were obtained.

Effect of the Invention

As clearly understood from the above explanations, according to the invention, since an amount of cordierite is increased and an amount of indialite is decreased, it is possible to obtain the low thermal expansion cordierite ceramic honeycomb, which decreases a thermal expansion coefficient.

1. A low thermal expansion cordierite ceramic honeycomb characterized in that a cordierite crystal phase is not lower than 60% and an indialite crystal phase is not greater than 30%, wherein a sum of the cordierite crystal phase and the indialite crystal phase is not lower than 85%.

2. The low thermal expansion cordierite ceramic honeycomb according to claim 1, wherein a thermal expansion coefficient along A-axis is not greater than 0.4×10⁻⁶/° C.

3. The low thermal expansion cordierite ceramic honeycomb according to claim 1, wherein a thickness of a partition wall of a cell is not greater than 100 μm.

4. A method of producing the low thermal expansion cordierite ceramic honeycomb according to one of claims 1-3, having the steps of mixing raw materials and forming agents to obtain a raw materials batch, extruding and drying the raw material batch to obtain a formed body, and sintering the formed body, characterized in that, during the sintering step, a temperature descending rate at least from a maximum temperature to 1300° C. is not greater than 100° C./hour.

5. The method of producing the low thermal expansion cordierite ceramic honeycomb according to claim 4, wherein a period for maintaining at the maximum temperature is not lower than 6 hours.

6. The method of producing the low thermal expansion cordierite ceramic honeycomb according to claim 4, wherein a temperature descending rate from the maximum temperature to 1250° C. is not greater than 50° C./hour.
